(19) United States
(12) Patent Application Publication
(10) Pub. No.: US 2011/0075022 A1
(43) Pub. Date: Mar. 31, 2011

(54) IMAGING DEVICE, ELECTRONIC APPARATUS INCLUDING THE SAME, AND METHOD OF MANUFACTURING IMAGING DEVICE

(75) Inventors: Takeshi Komuro, Kawasaki (JP); Manabu Hongo, Kawasaki (JP); Wataru Murata, Kawasaki (JP)

(73) Assignee: FUJITSU LIMITED, Kawasaki-shi (JP)

(21) Appl. No.: 12/882,416

(22) Filed: Sep. 15, 2010

(30) Foreign Application Priority Data
Sep. 16, 2009 (JP) 2009-214986

(51) Int. Cl. H04N 5/225; B32B 37/02

(52) U.S. Cl. 348/374; 156/278; 348/E05.024

(57) ABSTRACT

An imaging device includes an imaging unit, and a panel facing the imaging unit. The panel includes a panel body that has an anti-reflection-coated surface treated with anti-reflection coating and has a portion thereof overlapping an angle of view of the imaging unit, a sheet that is provided on a portion of the anti-reflection-coated surface outside of the angle of view, and a resin layer that has a pattern and is provided on a side of the sheet near the imaging unit.

### CROSS-REFERENCE TO RELATED APPLICATIONS

This application is based upon and claims the benefit of priority of the prior Japanese Patent Application No. 2009-214986, filed on Sep. 16, 2009, the entire contents of which are incorporated herein by reference.

### FIELD

The present invention relates to an imaging device, an electronic apparatus including the same, and a method of manufacturing an imaging device.

### BACKGROUND

Electronic apparatuses including imaging devices are known. For example, Japanese Laid-open Patent Publications No. 2003-274234 and No. 2004-40365 each disclose a mobile apparatus including an imaging device.

An imaging device may include an imaging unit and a transparent panel facing the imaging unit. By providing a pattern on the panel, the decorativeness of the imaging device is improved. In some cases, anti-reflection (AR) coating is provided on a surface of the panel near the imaging unit. A possible method of forming a pattern on the AR-coated surface includes applying resin to the AR-coated surface, forming a pattern on the resin, and hardening the resin. However, the adhesion between the AR-coated surface and resin is not good. Therefore, in some cases, a resin layer may not successively be provided on the AR-coated surface.

### SUMMARY

An imaging device includes an imaging unit, and a panel facing the imaging unit. The panel includes a panel body that has an anti-reflection-coated surface treated with anti-reflection coating and has a portion thereof overlapping an angle of view of the imaging unit, a sheet that is provided on a portion of the anti-reflection-coated surface outside of the angle of view, and a resin layer that has a pattern and is provided on a side of the sheet near the imaging unit.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF THE DRAWINGS

FIGS. 1A and 1B illustrates a mobile phone according to an embodiment;

FIG. 2A is an exploded perspective view of the mobile phone;

FIG. 2B is an enlarged view of a part including a panel;

FIG. 3 is a cross-sectional view taken along line A-A in FIG. 2B;

FIGS. 4A, 4B, 4C, and 4D illustrates a method of manufacturing an imaging device; and

FIG. 5 illustrates a method of manufacturing a panel different from the panel according to the embodiment.

### DESCRIPTION OF EMBODIMENTS

A mobile phone, which is an example of an electronic apparatus, is described below.

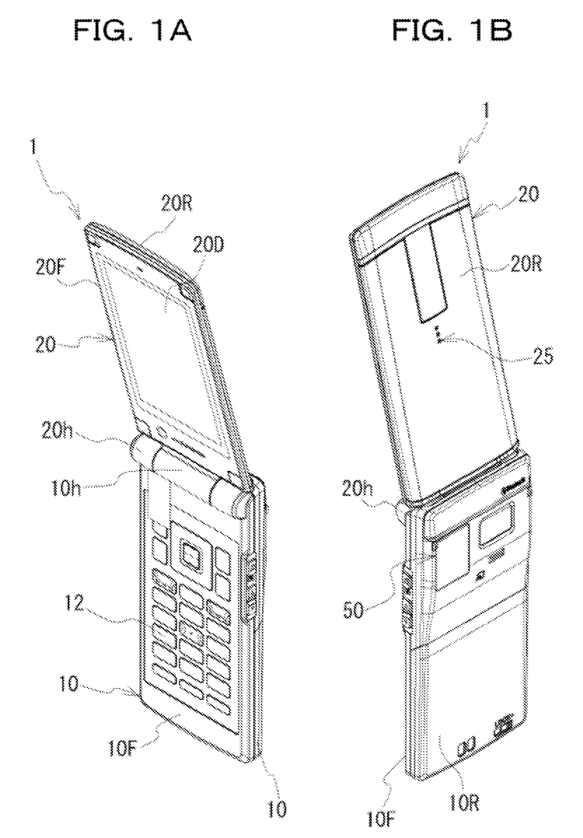

FIGS. 1A and 1B illustrate a mobile phone according to an embodiment. The mobile phone 1 includes casings 10 and 20. The casings 10 and 20 include hinge sections 10h and 20h, respectively, and are rotatably connected to each other with the hinge sections 10h and 20h. Thus, the casings 10 and 20 are openably/closably connected to each other. The casings 10 and 20 house electronic components and a printed circuit board. The casing 10 includes a front panel 10F and a rear panel 10R. The casing 20 includes a front panel 20F and a rear panel 20R. The front panel 10F is provided with a plurality of operation keys 12 for operating the mobile phone 1. The front panel 20F is provided with a display 20D. Referring to FIG. 1B, the rear panel 10R is provided with a panel 50.

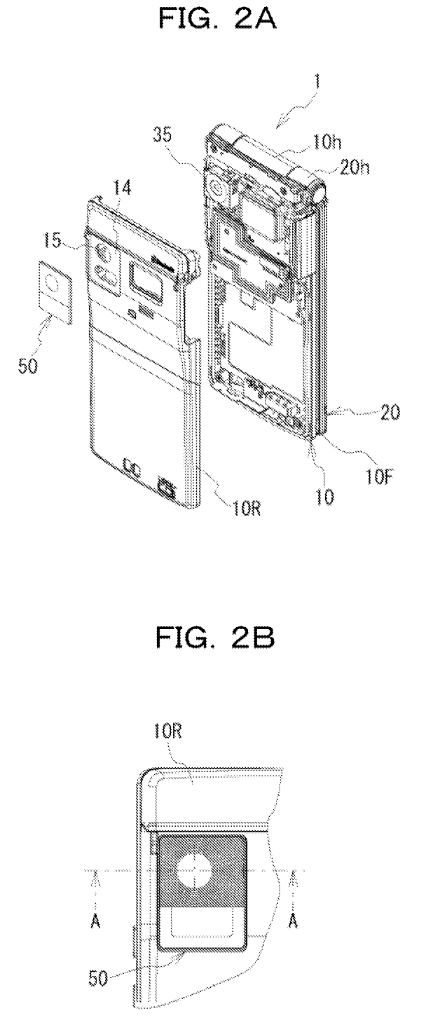

FIG. 2A is an exploded perspective view of the mobile phone 1. FIG. 2A illustrates the mobile phone 1 in a closed state with the casing 10 disassembled. The casing 10 houses an imaging unit 35. The imaging unit 35 includes a lens barrel made of synthetic resin and an imaging device housed in the lens barrel and configured to receive light from an object to be imaged. The casing 10 has in the outer surface thereof a recess 14 to which the panel 50 is fitted. The casing 10 also has an opening 15 allowing light to pass therethrough to reach the imaging unit 35.

FIG. 2B is an enlarged view of a part including the panel 50. The panel 50 has a pattern including a plurality of circles concentric with respect to a specific position. The pattern is provided on the outside of the angle of view of the imaging unit 35.

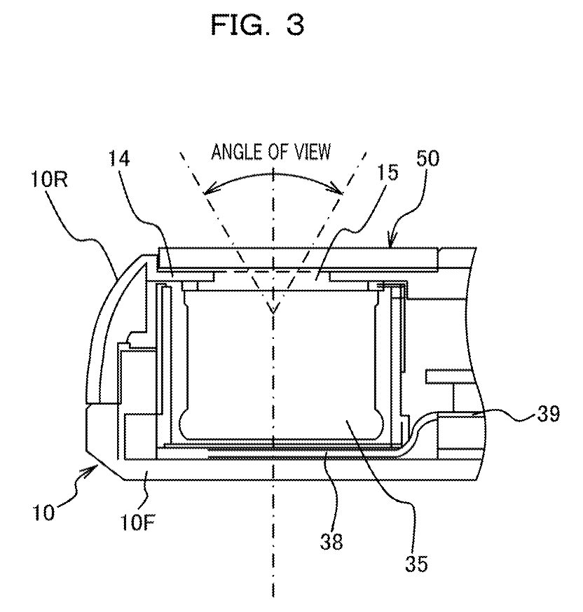

FIG. 3 is a cross-sectional view taken along line A-A in FIG. 2B. Referring to FIG. 3, the imaging unit 35 is held in the casing 10. The imaging unit 35 is electrically connected to a printed circuit board 39, held in the casing 10, with a flexible substrate 38 interposed therebetween.

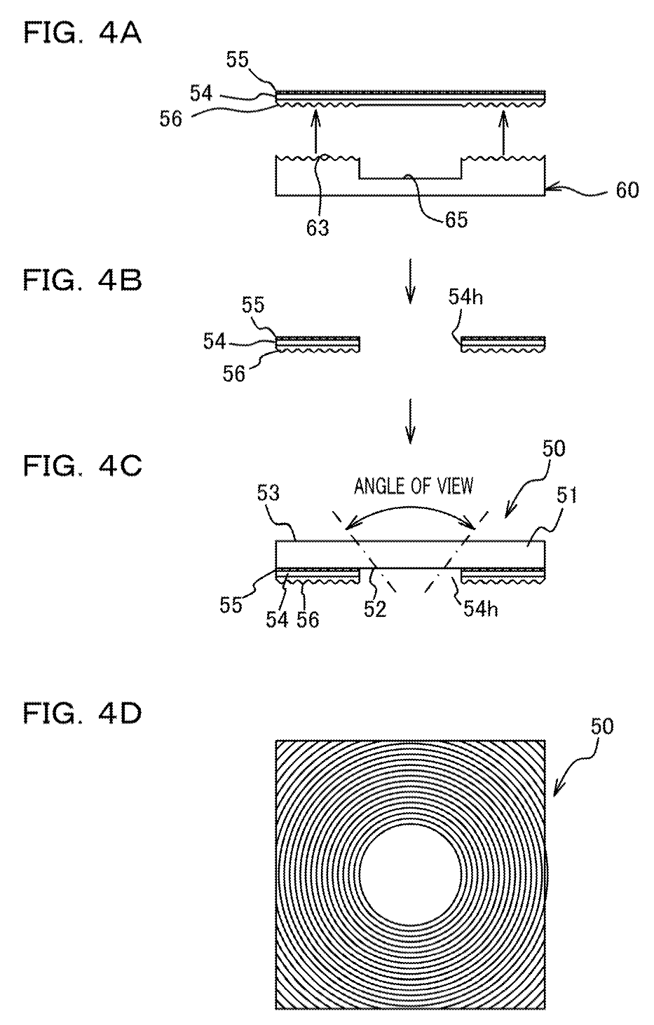

FIGS. 4A, 4B, 4C, and 4D illustrate a method of manufacturing an imaging device. Referring to FIG. 4A, a resin layer 56 is formed on one surface of a sheet 54. The resin layer 56 is formed by applying pre-hardened resin to the one surface of the sheet 54 with a dispenser or the like. The sheet 54 is made of polyethylene terephthalate (PET), for example. The sheet 54 is optically transparent. A piece of double-sided adhesive tape 55 is provided on the surface of the sheet 54 opposite the surface of the sheet 54 on which resin layer 56 is provided. The piece of double-sided adhesive tape 55 may be substituted by an adhesive agent.

A die 60 is intended for forming a pattern on the resin layer 56. The die 60 has a recess 65 and a transfer portion 63 around the recess 65. For example, the recess 65 may be in the center of the die 60. The transfer portion 63 is intended for pattern transfer onto the resin layer 56. The pattern may include a plurality of circles concentric with respect to the recess 65, for example. The transfer portion 63 is pressed against the resin layer 56 before the resin layer 56 is hardened, whereby the pattern of the transfer portion 63 is transferred to the resin layer 56. After the transfer, the resin layer 56 is hardened. For example, ultraviolet rays may be applied to harden the resin layer 56.

Referring to FIG. 4B, an opening 54h is provided in a portion of the resin layer 56 not having the pattern by punching or the like.

Referring to FIG. 4C, the surface of the sheet 54 having the piece of double-sided adhesive tape 55 is made to adhere to an AR-coated surface 52 of a panel body 51. Thus, the panel 50 having the pattern shown in FIG. 4D is obtained. The panel body 51 is made of synthetic resin. The AR-coated surface 52 faces the imaging unit 35. The AR-coated surface 52 has been treated with AR coating intended for prevention of reflection. The panel 50 is bonded to the recess 14 of the rear panel 10R with an adhesive or the like. The rear panel 10R and the front panel 10F are assembled together. Thus, the panel 50 is positioned in such a manner as to face the imaging unit 35.

Referring to FIGS. 4C and 4D, the panel 50 includes the panel body 51, the sheet 54, the piece of double-sided adhesive tape 55, and the resin layer 56. The panel body 51 has the AR-coated surface 52 facing the imaging unit 35 and an opposite surface 53 facing the object to be imaged. The panel body 51 has a portion thereof overlapping the angle of view of the imaging unit 35. The sheet 54 is provided on a portion of the AR-coated surface 52 on the outside of the angle of view. The resin layer 56 is provided on the side of the sheet 54 near the imaging unit 35 and has the pattern transferred thereto. When the panel body 51 is processed, the panel body 51 is held, with a jig or the like, at a portion thereof on which the sheet 54 is not to be provided.

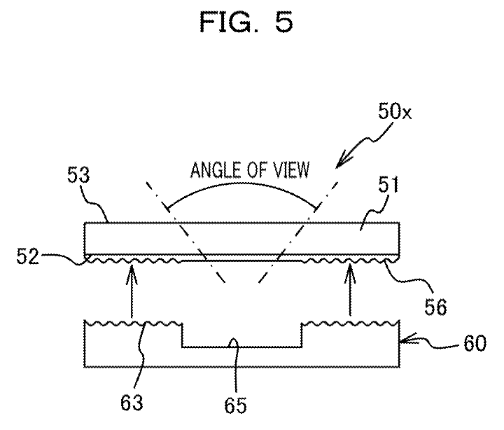

FIG. 5 illustrates a method of manufacturing a panel different from the panel according to the embodiment. In a case illustrated in FIG. 5, resin is applied to the AR-coated surface 52 of a panel 50x, a pattern on the die 60 is transferred onto the resin layer 56, and the resin layer 56 is hardened. Since the AR-coated surface 52 is treated with AR coating, the resin layer 56 that has been hardened may peel off the AR-coated surface 52. Such poor adhesion between the AR-coated surface 52 and the resin layer 56 is at least partly because of the following reason. In AR coating, an object is coated with a thin film of metal. The thin film, deposited on the AR-coated surface 52, is metal. The molecular structures of resin and metal greatly differ from each other. Therefore, the adhesion between resin and metal is poor. In the case shown in FIG. 5, since the resin layer 56 has a portion thereof overlapping the angle of view, the image quality may be affected.

In the method according to the embodiment shown in FIGS. 4A to 4D, however, the resin layer 56 is provided on one surface of the sheet 54, a pattern is formed on the resin layer 56, and the opposite surface of the sheet 54 is made to adhere to the AR-coated surface 52 of the panel 50. In this method, since the resin layer 56 is not directly provided on the AR-coated surface 52 of the panel 50, there is little possibility that the resin layer 56 that has been hardened peels off the sheet 54. Thus, the resin layer 56 having a pattern is provided on the side of the panel body 51 having the AR-coated surface 52.

The opening 54h prevents the sheet 54 from overlapping the angle of view of the imaging unit 35. That is, the sheet 54, the piece of double-sided adhesive tape 55, and the resin layer 56 are provided outside of the angle of view of the imaging unit 35. Therefore, deterioration of image quality of the imaging unit 35 due to the presences of the sheet 54, the piece of double-sided adhesive tape 55, and the resin layer 56 is prevented.

The sheet 54, the piece of double-sided adhesive tape 55, and the resin layer 56 are provided on the surface of the panel body 51 near the imaging unit 35. In other words, the sheet 54 and the other foregoing elements are provided on the inner surface of the panel body 51. That is, the sheet 54 and the other elements are housed in the casing 10, thereby being prevented from peeling off the panel body 51.

While a specific embodiment of the present invention has been described above, the present invention is not limited to such a specific embodiment, and various changes and modifications may be made to the embodiment within the scope of the present invention defined in the appended claims.

The electronic apparatus is not limited to mobile phones. For example, the electronic apparatus may be a personal digital assistant (PDA) or a notebook personal computer. The electronic apparatus may be either a mobile apparatus or a desktop apparatus.

It is also acceptable that, after the resin layer 56 having a pattern is provided on one surface of the sheet 54 and the opening 54h is provided, a piece of double-sided adhesive tape 55 is provided on the opposite surface of the sheet 54.

According to the embodiment, there are provided an imaging device in which a resin layer having a pattern is provided on the side of a panel body having an AR-coated surface, an electronic apparatus including the same, and a method of manufacturing an imaging device enabling a resin layer having a pattern to be provided on the side of a panel body having an AR-coated surface.

All examples and conditional language recited herein are intended for pedagogical purposes to aid the reader in understanding the principles of the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiment of the present invention has been described in detail, it should be understood that the various changes, substitutions, and alterations could be made hereto without departing from the spirit and scope of the invention.

What is claimed is:

1. An imaging device comprising:
an imaging unit; and
a panel facing the imaging unit and including
a panel body that has an anti-reflection-coated surface treated with anti-reflection coating and has a portion thereof overlapping an angle of view of the imaging unit,
a sheet that is provided on a portion of the anti-reflection-coated surface outside of the angle of view, and
a resin layer that has a pattern and is provided on a side of the sheet near the imaging unit.

2. The imaging device according to claim 1, wherein the sheet has an opening so that the sheet does not overlap with the angle of view.

3. An electronic apparatus comprising:
an imaging unit; and
a panel facing the imaging unit and including
a panel body that has an anti-reflection-coated surface treated with anti-reflection coating and has a portion thereof overlapping an angle of view of the imaging unit,
a sheet that is provided on a portion of the anti-reflection-coated surface outside of the angle of view, and
a resin layer that has a pattern and is provided on a side of the sheet near the imaging unit; and
a casing housing the imaging unit and holding the panel.

4. A method of manufacturing an imaging device, the method comprising:
applying a resin layer on one surface of a sheet;
forming a pattern on the resin layer;
hardening the resin layer;
adhering an opposite surface of the sheet to an anti-reflection-coated surface of a panel body treated with anti-reflection coating; and
positioning the panel body such that the panel body faces an imaging unit and the sheet is positioned outside of an angle of view of the imaging unit.

5. The method according to claim 4, further comprising:
providing an opening in the resin layer and the sheet so that the resin layer and the sheet do not overlap the angle of view.
